(19) United States
(12) Patent Application Publication
(10) Pub. No.: US 2019/0218858 A1
(43) Pub. Date: Jul. 18, 2019

(54) Shade Structure with Related Combination Figures

(71) Applicant: My Home Global Company, ErShui Township (TW)

(72) Inventor: Ju-Huai Chen, ErShui Township (TW)

(21) Appl. No.: 15/870,925

(22) Filed: Jan. 13, 2018

(51) Int. Cl. E06B 9/42

(52) U.S. Cl. CPC E06B 9/42; A47H 23/00

(57) ABSTRACT

A shade structure includes a shading member (1) having a first section (13), a second section (14) and a plurality of successive sections (15), a first figure face (2) mounted on the first section, a second figure face (3) mounted on the second section and presenting a determined figure related to that of the first figure face, a plurality of successive figure faces (4) mounted on the successive sections and presenting a determined figure related to that of the first figure face and the second figure face, and a plurality of connecting units (5) arranged between the first section, the successive sections and the second section and connected mutually to overlap and fold the shading member which has different folded states.

### BACKGROUND OF THE INVENTION

### 1. Field of the Invention

The present invention relates to a covering and, more particularly, to a shade structure for a window, a door, a bathroom or the like.

### 2. Description of the Related Art

A conventional foldable shade structure, such as a cordless magnetically attractive shade, comprises a shading face and a plurality of magnetic units mounted on the shading face. In use, when the bottom of the shading face is lifted to overlap the shading face, the magnetic units are attracted magnetically, so that the shading face is partially folded, half folded or fully folded to adjust the incident sunlight so as to regulate the shading effect and the indoor brightness according to the user's requirement, thereby providing a comfortable sensation to the user. The shading face is made of cloth that presents figures so as to enhance the outer appearance of the shade structure. However, when the shading face is folded upward, the shading face overlaps so that the figures of the shading face have an unexpected break, thereby decreasing the aesthetic quality of the shade structure when the shading face is folded upward.

### BRIEF SUMMARY OF THE INVENTION

The primary objective of the present invention is to provide a shade structure with interrelated combination figures that are consistent when the shade structure is folded partially.

In accordance with the present invention, there is provided a shade structure comprising a shading member, a first figure face, a second figure face, a plurality of successive figure faces and a plurality of connecting units. The shading member includes an outer face and an inner face. The shading member has an upper end provided with a first section, a lower end provided with a second section, and a mediate position provided with a plurality of successive sections. The first section, the second section and the successive sections of the shading member are folded to overlap mutually so as to fold the shading member. The first figure face is mounted on the first section of the shading member. The second figure face is mounted on the second section of the shading member and presents a determined figure related to that of a lower end of the first figure face. The successive figure faces are mounted on the successive sections of the shading member. The successive figure faces are interrelated and connected mutually. The successive figure faces present a determined figure related to that of the first figure face and the second figure face. The connecting units are arranged at junctions between the first section and the successive sections, between the successive sections, and between the successive sections and the second section. Each of the connecting units includes a first connector and a second connector. The first connector of one of the connecting units is connected with the second connector of another one of the connecting units, so that the two of the connecting units are connected. The connecting units are connected mutually to overlap and fold the shading member, so as to change a relative position between the first section, the second section and the successive sections of the shading member, and to change a relative position between the first figure face, the second figure face and the successive figure faces.

According to the primary advantage of the present invention, the figures of the first figure face, the second figure face and the successive figure faces are interrelated, so that when the first figure face, the second figure face and the successive figure faces are disposed at different overlapping states, the first figure face, the second figure face and the successive figure faces still keep a consistent figure without incurring an abrupt break, thereby enhancing the aesthetic quality and visible effect of the shading member.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a shade structure in accordance with the preferred embodiment of the present invention.

FIG. 2 is a front view of the shade structure as shown in FIG. 1.

FIG. 3 is a partially exploded view of the shade structure as shown in FIG. 2.

FIG. 4 is a schematic operational view of the shade structure as shown in FIG. 1 in use.

FIG. 5 is another schematic operational view of the shade structure as shown in FIG. 1 in use.

FIG. 6 is a locally enlarged view of the shade structure as shown in FIG. 5.

FIG. 7 is a perspective view of a shade structure in accordance with another preferred embodiment of the present invention.

FIG. 8 is a schematic operational view of the shade structure as shown in FIG. 7 in use.

FIG. 9 is another schematic operational view of the shade structure as shown in FIG. 7 in use.

### DETAILED DESCRIPTION OF THE INVENTION

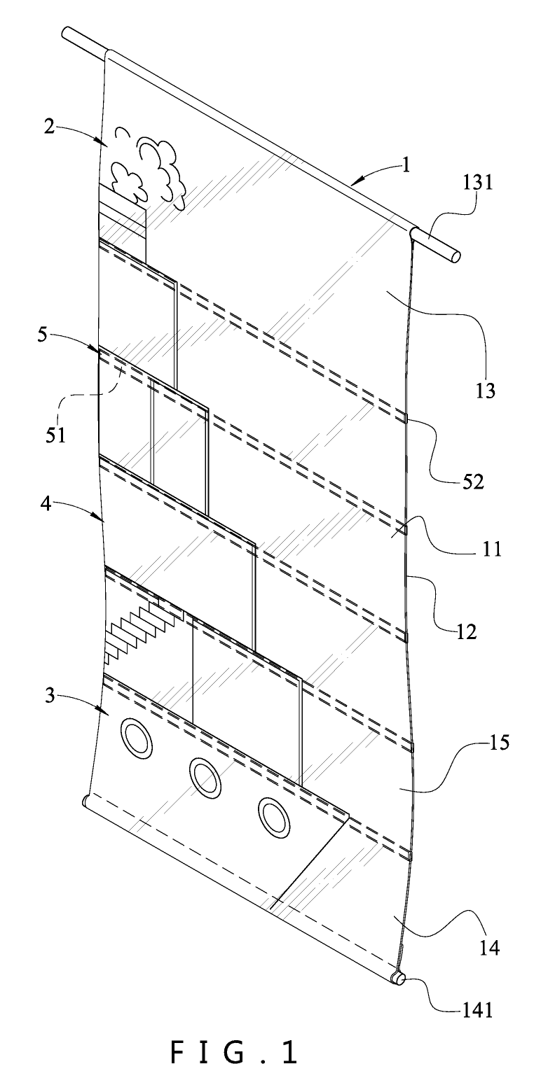

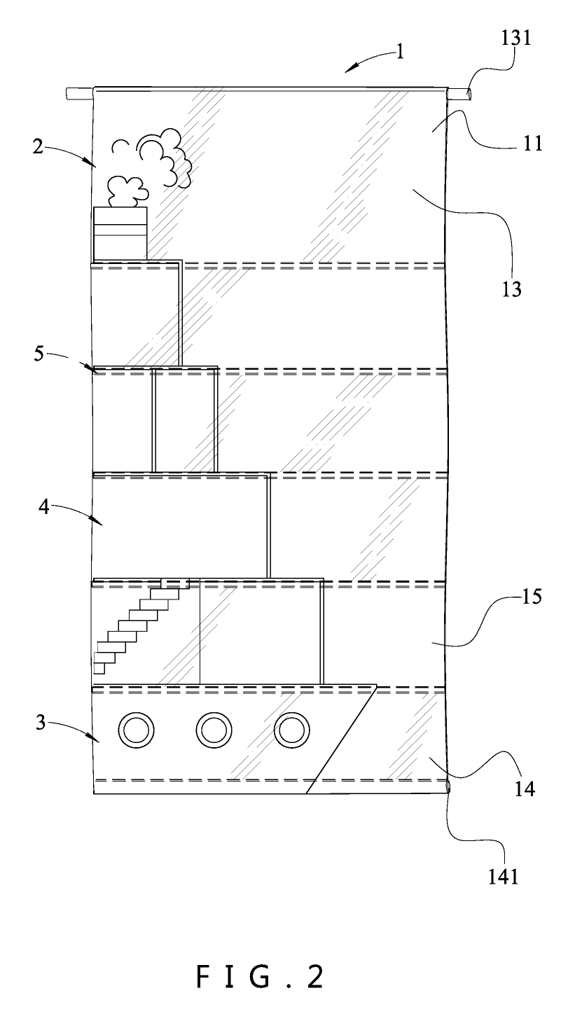

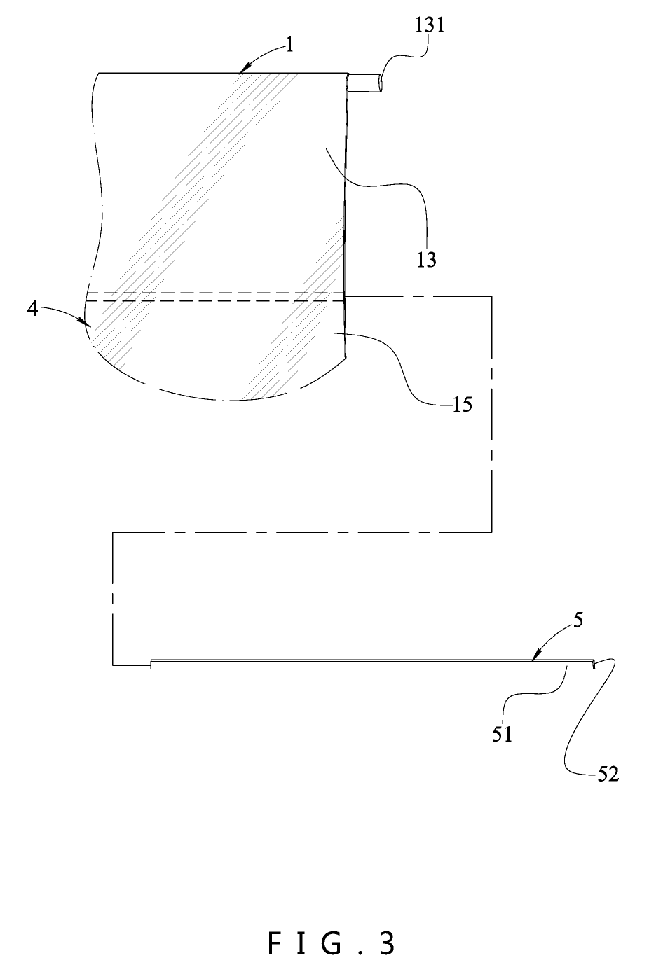

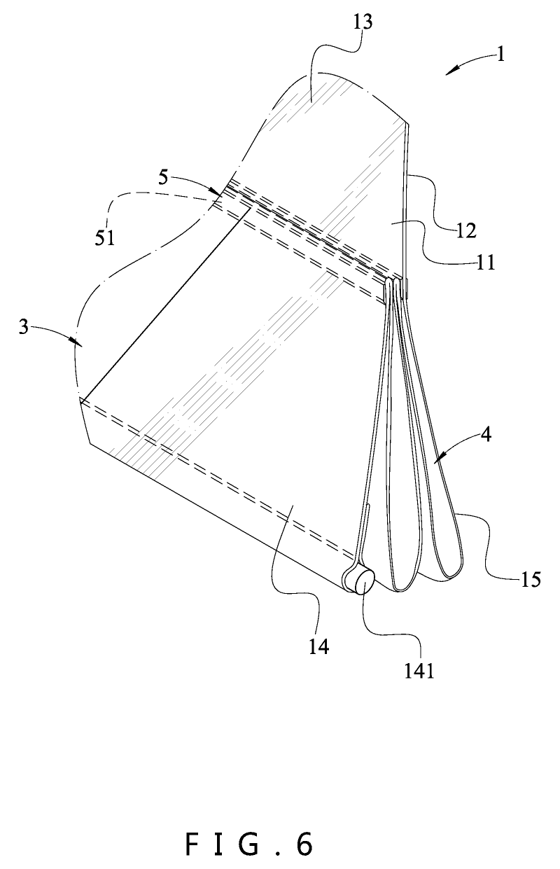

Referring to the drawings and initially to FIGS. 1-6, a shade structure in accordance with the preferred embodiment of the present invention comprises a shading member 1, a first figure face 2, a second figure face 3, a plurality of successive figure faces 4 and a plurality of connecting units 5.

The shading member 1 includes an outer face 11 and an inner face 12. The shading member 1 has an upper end provided with a first section 13, a lower end provided with a second section 14, and a mediate position provided with a plurality of successive sections 15. The first section 13, the second section 14 and the successive sections 15 of the shading member 1 are folded to overlap mutually so as to fold the shading member 1.

The first figure face 2 is mounted on the first section 13 of the shading member 1.

The second figure face 3 is mounted on the second section 14 of the shading member 1. The second figure face 3 presents a determined figure related to that of a lower end of the first figure face 2.

The successive figure faces 4 are mounted on the successive sections 15 of the shading member 1. The successive figure faces 4 are interrelated and connected mutually. The successive figure faces 4 present a determined figure related to that of the first figure face 2 and the second figure face 3.

The connecting units 5 are arranged at junctions between the first section 13 and the successive sections 15, between the successive sections 15, and between the successive sections 15 and the second section 14. Each of the connecting units 5 includes a first connector 51 and a second connector 52. Preferably, the connecting units 5 are secured to the inner face 12 of the shading member 1 or sandwiched between the outer face 11 and the inner face 12 of the shading member 1 by sewing, without interfering with the figures.

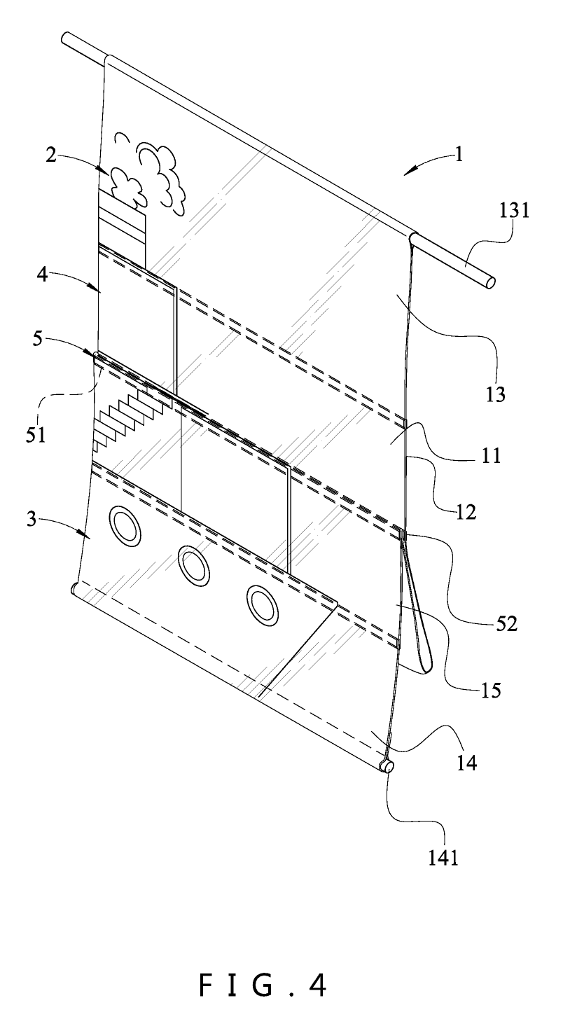

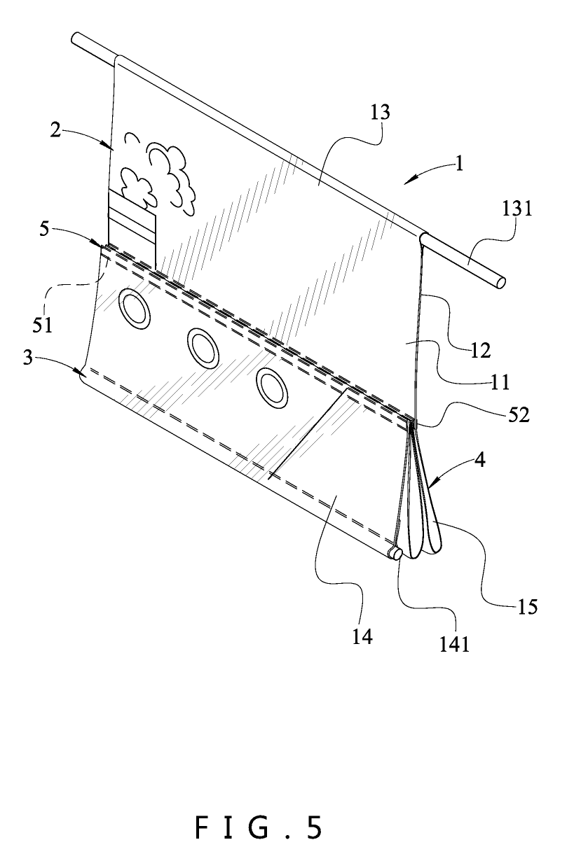

In practice, the first connector 51 of one of the connecting units 5 is connected with the second connector 52 of another one of the connecting units 5, so that the two of the connecting units 5 are connected. In such a manner, the connecting units 5 are connected mutually to overlap and fold the shading member 1 as shown in FIGS. 4-6, so as to change a relative position between the first section 13, the second section 14 and the successive sections 15 of the shading member 1, and to change a relative position between the first figure face 2, the second figure face 3 and the successive figure faces 4. Thus, the shading member 1 presents different types of figures that are changed by connecting the connecting units 5 partially or wholly. As shown in FIG. 4, when the successive figure faces 4 overlap partially by connecting the connecting units 5 partially, the first figure face 2, the second figure face 3 and the successive figure faces 4 that are not covered, still keep a consistent figure without incurring an abrupt break, thereby enhancing the aesthetic quality of the shading member 1. As shown in FIG. 5, the successive figure faces 4 overlap wholly, so that the first figure face 2 and the second figure face 3 are connected.

In the preferred embodiment of the present invention, the shading member 1 is made of cloth, silk, paper, plastic sheet, yarn or artificial fiber.

In the preferred embodiment of the present invention, the first figure face 2, the second figure face 3 and the successive figure faces 4 are located at the outer face 11 or the inner face 12 of the shading member 1.

In the preferred embodiment of the present invention, the first figure face 2, the second figure face 3 and the successive figure faces 4 present successive and extendable figures or successive and non-extendable figures.

In the preferred embodiment of the present invention, the first connector 51 and the second connector 52 of the connecting units 5 are connected by magnetically attracting, loop-and-hook closure, snap-fastening or hooking.

In the preferred embodiment of the present invention, the first section 13 of the shading member 1 has an upper end provided with a mounting portion 131 that is attached by hanging, screwing or adhering to an object, such as a window, a door, a bathroom or the like.

In the preferred embodiment of the present invention, the second section 14 of the shading member 1 has a lower end provided with a weight portion 141 to pull the shading member 1 downward by the gravity of the weight portion 141, so that the shading member 1 is kept at a flat state.

In the preferred embodiment of the present invention, the first section 13, the second section 14 and the successive sections 15 of the shading member 1 are made of different material and are assembled together, to enhance the visible effect of the shading member 1.

In the preferred embodiment of the present invention, the shading member 1 is made of transparent or translucent material (such as plastic cloth), so that the figures of the first figure face 2, the second figure face 3 and the successive figure faces 4 form an overlapping effect when the first figure face 2, the second figure face 3 and the successive figure faces 4 overlap. In addition, the user can draw on the shading member 1 by water-based paints that are erased easily.

In the preferred embodiment of the present invention, the first figure face 2, the second figure face 3 and the successive figure faces 4 form an integral figure that is presented by multiple lines for coloring of the user, to enhance the interactive effect of the shading member 1.

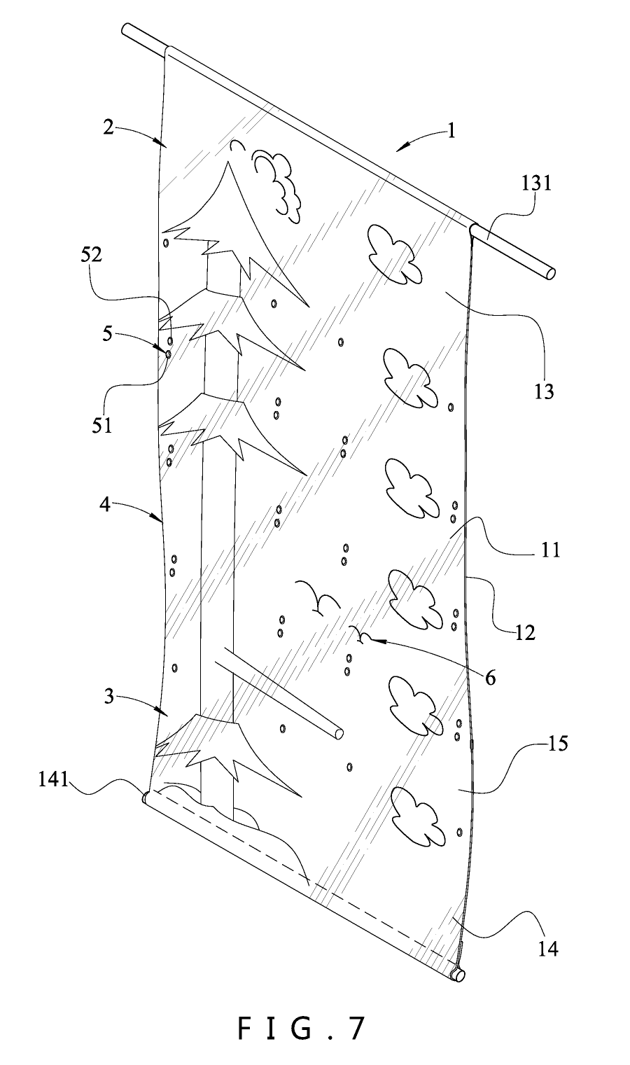

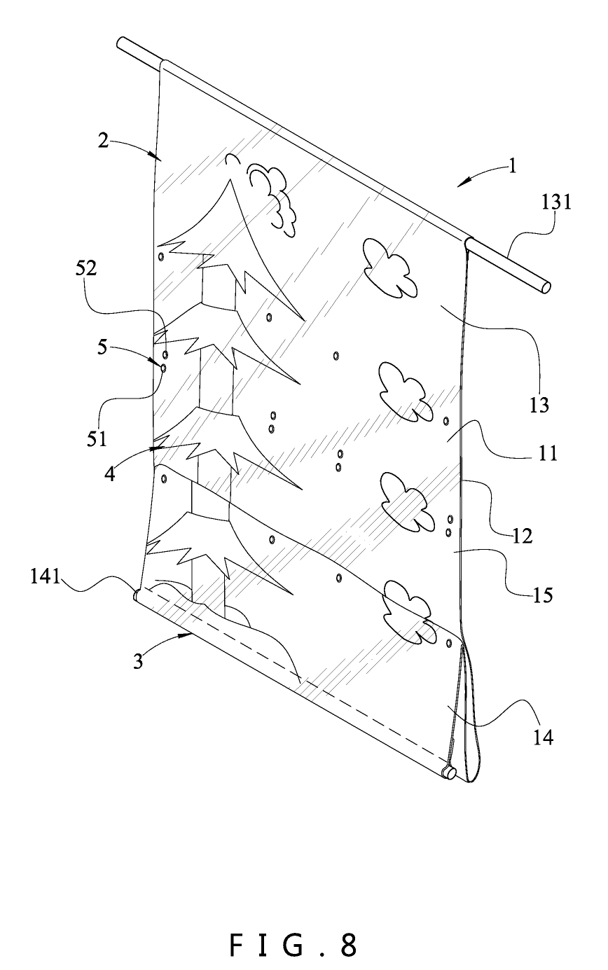

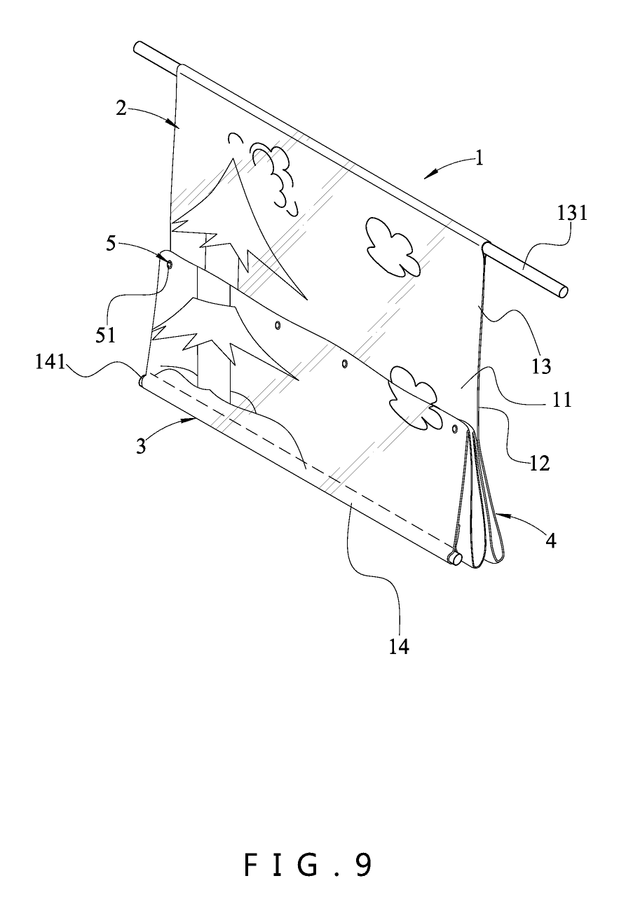

Referring to FIGS. 7-9, the shade structure further comprises a third figure face 6 mounted on the first section 13, the second section 14 and the successive sections 15 of the shading member 1. The third figure face 6 presents a figure (such as seagulls) unrelated to that of the first figure face 2, the second figure face 3 and the successive figure faces 4, to enhance the amusement of the shading member 1. Preferably, the connecting units 5 are snap fasteners. The first figure face 2, the second figure face 3 and the successive figure faces 4 present successive and extendable figures (such as tree branches). Alternatively, the first figure face 2, the second figure face 3 and the successive figure faces 4 present successive and non-extendable figures (such as clouds). As shown in FIG. 8, when the successive figure faces 4 overlap partially, the first figure face 2, the second figure face 3 and the successive figure faces 4 that are not covered, still keep a consistent figure. In addition, the third figure face 6 is covered and hidden by the successive figure faces 4. As shown in FIG. 9, the successive figure faces 4 overlap wholly, so that the first figure face 2 and the second figure face 3 are connected. At this time, the first figure face 2 and the second figure face 3 still keep a consistent figure.

Accordingly, the figures of the first figure face 2, the second figure face 3 and the successive figure faces 4 are interrelated, so that when the first figure face 2, the second figure face 3 and the successive figure faces 4 are disposed at different overlapping states, the first figure face 2, the second figure face 3 and the successive figure faces 4 still keep a consistent figure without incurring an abrupt break, thereby enhancing the aesthetic quality and visible effect of the shading member 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A shade structure comprising:
a shading member (1), a first figure face (2), a second figure face (3), a plurality of successive figure faces (4) and a plurality of connecting units (5);
wherein:
the shading member includes an outer face (11) and an inner face (12);
the shading member has an upper end provided with a first section (13), a lower end provided with a second section (14), and a mediate position provided with a plurality of successive sections (15);
the first section, the second section and the successive sections of the shading member are folded to overlap mutually so as to fold the shading member;
the first figure face is mounted on the first section of the shading member;
the second figure face is mounted on the second section of the shading member and presents a determined figure related to that of a lower end of the first figure face;
the successive figure faces are mounted on the successive sections of the shading member;
the successive figure faces are interrelated and connected mutually;
the successive figure faces present a determined figure related to that of the first figure face and the second figure face;
the connecting units are arranged at junctions between the first section and the successive sections, between the successive sections, and between the successive sections and the second section;
each of the connecting units includes a first connector (51) and a second connector (52);
the first connector of one of the connecting units is connected with the second connector of another one of the connecting units, so that the two of the connecting units are connected; and
the connecting units are connected mutually to overlap and fold the shading member, so as to change a relative position between the first section, the second section and the successive sections of the shading member, and to change a relative position between the first figure face, the second figure face and the successive figure faces.

2. The shade structure of claim 1, wherein the shading member is made of cloth, silk, paper, plastic sheet, yarn or artificial fiber.

3. The shade structure of claim 1, wherein the first figure face, the second figure face and the successive figure faces are located at the outer face or the inner face of the shading member.

4. The shade structure of claim 1, wherein the first figure face, the second figure face and the successive figure faces present successive and extendable figures or successive and non-extendable figures.

5. The shade structure of claim 1, further comprising:
a third figure face (6) mounted on the first section, the second section and the successive sections of the shading member and presenting a figure unrelated to that of the first figure face, the second figure face and the successive figure faces.

6. The shade structure of claim 1, wherein the first connector and the second connector of the connecting units are connected by magnetically attracting, loop-and-hook closure, snap-fastening or hooking.

7. The shade structure of claim 1, wherein the first section of the shading member has an upper end provided with a mounting portion (131) that is attached by hanging, screwing or adhering.

8. The shade structure of claim 1, wherein the second section of the shading member has a lower end provided with a weight portion (141).

9. The shade structure of claim 1, wherein the first section, the second section and the successive sections of the shading member are made of different material and are assembled together.

10. The shade structure of claim 1, wherein the shading member is made of transparent material, so that the figures of the first figure face, the second figure face and the successive figure faces form an overlapping effect when the first figure face, the second figure face and the successive figure faces overlap.
